(19) United States
(12) Patent Application Publication
(10) Pub. No.: US 2016/0216653 A1
(43) Pub. Date: Jul. 28, 2016

(54) PRINTING DEVICE AND PRINTING CONTROL METHOD

(71) Applicant: CASIO COMPUTER CO., LTD., Shibuya-ku, Tokyo (JP)

(72) Inventors: Toshiaki YAJIMA, Iruma-shi, Saitama (JP); Toshihiko NUMAZU, Sayama-shi, Saitama (JP); Toshio NAGASAKA, Iruma-shi, Saitama (JP)

(73) Assignee: CASIO COMPUTER CO., LTD., Shibuya-ku, Tokyo (JP)

(21) Appl. No.: 14/917,266

(22) PCT Filed: Sep. 12, 2014
(86) PCT No.: PCT/JP2014/074288

§ 371 Date: Mar. 7, 2016

(30) Foreign Application Priority Data
Sep. 20, 2013 (JP) 2013-196095

(51) Int. Cl. G03G 15/20

(52) U.S. Cl. CPC G03G 15/205

(57) ABSTRACT

A printing device includes a recording-medium-type reader that reads a type of a recording medium, a fixing-unit attachment that selectively attaches any one of a plurality of fixing units, the plurality of fixing units being different types from one another, and a conformity determiner that determines whether or not the type of the fixing unit attached in the fixing-unit attachment is conformed to the type of the recording medium read by the recording-medium-type reader.

### TECHNICAL FIELD

The present disclosure relates to a printing device, a printing control method, and a program.

### BACKGROUND ART

According to printing devices, in general, heat and pressure are applied by rollers to heat a transferred toner image and to fix such a toner image on a recording medium. In the case of continuous printing, according to such printing devices, when a heating width of a roller is wider than a recording width of a recording medium, the temperature of a portion of the roller where no recording medium passes rises. When the portion of the roller where no recording medium passes reaches an overheat temperature condition, a printing operation is stopped by a safety protection control, and the printing devices sometimes become unable to restart the printing operation until such a temperature becomes equal to or lower than a preset temperature.

Patent Literature 1 discloses a technology of stopping a power supply to a heater when the temperature of the portion of a roller where no recording medium passes exceeds a preset temperature, calculating a time until a temperature difference between a portion where a recording medium passes and the portion where no recording medium passes falls into a preset temperature difference, and displaying such a time.

### CITATION LIST

### Patent Literature

Patent Literature 1: Unexamined Japanese Patent Application Kokai Publication No. 2013-15576

### SUMMARY OF INVENTION

### Technical Problem

However, according to the technology disclosed in Patent Literature 1, although a printing restart time is predictable, the printing operation is suspended until the printing restart time, and thus a printing efficiency is not excellent.

The present disclosure has been made in view of the aforementioned circumstances, and it is an objective of the present disclosure to provide a printing device, a printing control method and a program which can avoid a suspension of printing operation.

In addition, it is another objective of the present disclosure to provide a printing device, a printing control method and a program which have a high printing efficiency.

### Solution to Problem

A printing device according to an aspect of the present disclosure includes:

a recording-medium-type reader that reads a type of a recording medium;

a fixing-unit attachment that selectively attaches any one of a plurality of fixing units, the plurality of fixing units being different types from one another; and

a conformity (compatibility) determiner that determines whether or not the type of the fixing unit attached in the fixing-unit attachment is conformed to the type of the recording medium read by the recording-medium-type reader.

In addition, a printing control method according to another aspect of the present disclosure includes:

a recording-medium-type reading step of reading a type of a recording medium;

a fixing-unit attaching step of selectively attaching any one of a plurality of fixing units, the plurality of fixing units being different types from one another; and

a conformity determining step of determining whether or not the type of the fixing unit attached in the fixing-unit attaching step is conformed to the type of the recording medium read in the recording-medium-type reading step.

Still further, a program according to the other aspect of the present disclosure causes a computer to execute:

a recording-medium-type reading process of reading a type of a recording medium;

a fixing-unit attaching process of selectively attaching any one of a plurality of fixing units, the plurality of fixing units being different types from one another; and

a conformity determining process of determining whether or not the type of the fixing unit attached in the fixing-unit attaching process is conformed to the type of the recording medium read in the recording-medium-type reading process.

### Advantageous Effects of Invention

According to the present disclosure, a suspension of printing operation of a printing device becomes avoidable.

### BRIEF DESCRIPTION OF DRAWINGS

FIG. 1 is a diagram exemplary illustrating an entire structure of a printing device according to a first embodiment of the present disclosure;

FIG. 2A is a diagram illustrating a structure to detect a recording width of a recording medium, and is a table indicating a correspondence relationship between an ON/OFF state of a switch and a recording width of a recording medium;

FIG. 2B is a circuit diagram to detect a recording width of a recording medium;

FIG. 3 is a cross-sectional view illustrating an internal structure of an image forming device;

FIG. 4A is a schematic diagram illustrating an internal structure of a fixing unit, is a cross-sectional view orthogonal to a lengthwise direction of a fixing roller and that of a pressure applying roller, and is also a cross-sectional view along a line B-B in FIG. 4B;

FIG. 4B is a cross-sectional view along a line A-A in FIG. 4A;

FIG. 5A is a diagram illustrating a structure to detect a type of a fixing unit, and is a table illustrating a correspondence relationship between a type of a fixing unit and a detected voltage;

FIG. 5B is a circuit diagram to detect a type of a fixing unit;

FIG. 6 is a diagram illustrating a heater combination built in a fixing roller for each type of a fixing unit;

FIG. 7 is a block diagram illustrating a structure with respect to a control of the image forming device;

FIG. 8A is a diagram illustrating a fixing-unit association table that has a type of a fixing unit, a recording width of a recording medium, and selection information on either a first heater or a second heater associated one another;

FIG. 8B is a diagram illustrating a fixing-unit association table that has a type of a fixing unit, a heating width of the first heater, that of the second heater, and a recording width of a recording medium associated one another;

FIG. 9 is a graph illustrating a transition of a surface temperature of a portion of a fixing roller where no recording medium passes;

FIG. 10A is a diagram illustrating an image of a surface temperature distribution of a fixing roller when the first heater that has a heating width conformed to the width of B4 format or the second heater that has a heating width conformed to the width of A3 format is utilized;

FIG. 10B is a diagram illustrating an image of a surface temperature distribution of a fixing roller when the first heater that has a heating width conformed to the width of A4 format or the second heater that has a heating width conformed to the width of A3 format is utilized;

FIG. 10C is a diagram illustrating an image of a surface temperature distribution of a fixing roller when the first heater that has a heating width conformed to the width of A5 format or the second heater that has a heating width conformed to with the width of A3 format is utilized;

FIG. 11 is a flowchart for a conformity determining process executed by the printing device according to the first embodiment;

FIG. 12 is a diagram illustrating a message screen provided by the printing device according to the first embodiment;

FIG. 13 is a flowchart for a conformity determining process executed by the printing device according to a second embodiment;

FIG. 14 is a diagram illustrating a message screen provided by the printing device according to the second embodiment; and

FIG. 15 is a flowchart for a conformity determining process executed by the printing device according to a modified example of the present disclosure.

### DESCRIPTION OF EMBODIMENTS

Further objects and advantages of the present disclosure will be set forth in the description which follows, a part of them will be apparent from the description, or may be understood by practice of the present disclosure. The objects and advantages of the present disclosure may be realized and obtained by means and combinations thereof particularly pointed out hereinafter.

The accompanying drawings are incorporated in a part of the specification, and constitute a part of the specification to illustrate embodiments of the present disclosure. In addition, the accompanying drawings together with the general description given above and the detailed description of the embodiments given below serve to explain the principles of the present disclosure.

Embodiments of the present disclosure will be described below in detail with reference to the accompanying drawings. Note that components of the same or equivalent functions in the drawings are indicated by the same reference signs.

Each of the following embodiments is to explain the present disclosure, and is not to limit the scope and spirit of the present disclosure. Hence, persons skilled in the art are capable of carrying out embodiments in which each of the following structural elements is replaced with an equivalent, and such embodiments are also within the scope and spirit of the present disclosure. In addition, in the following explanation, an explanation for a conventionally well-known technical matter not important to facilitate understanding to the present disclosure will be omitted accordingly.

### First Embodiment

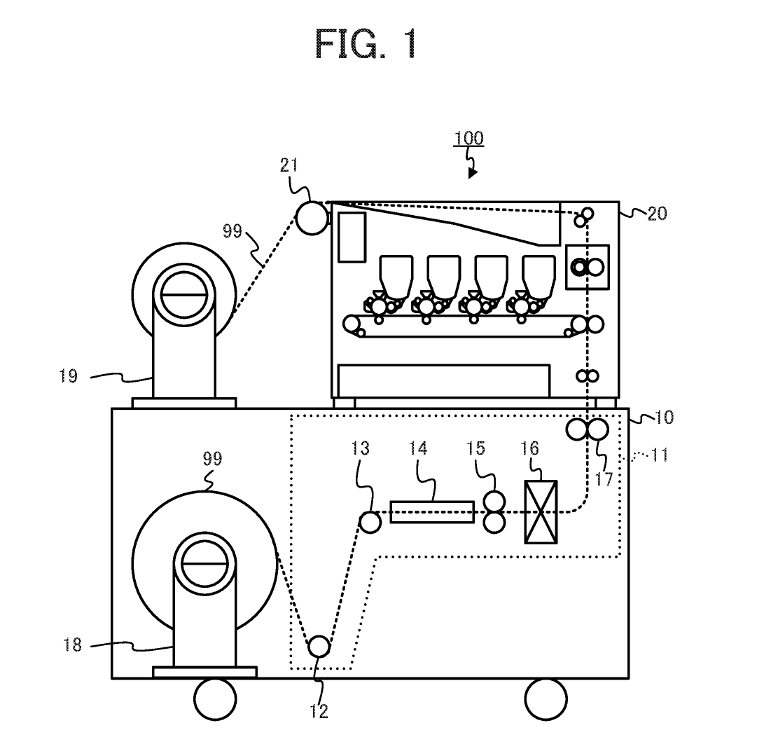

FIG. 1 illustrates an entire structure of a printing device according to a first embodiment of the present disclosure. A printing device 100 includes a supply device 10, and an image forming device 20. Note that according to this first embodiment, although a recording medium 99 in a rolled shape is shown as a recording medium for image formation, the present disclosure is not limited to this case, and a cut-out recording medium, a continuous recording medium with sprocket holes, and the like are also applicable.

The supply device 10 supplies the rolled recording medium 99 to the image forming device 20. The supply device 10 winds off the recording medium 99 continuously which is the recording medium wound around a winding core (a tube) in a rolled shape, and conveys the recording medium to the image forming device 20. The supply device 10 includes a holder (an unwinder) 18 and a conveyer 11. In addition, the supply device 10 further includes a winder (a rewinder) 19 thereon. The supply device 10 serves as a supplier according to the present disclosure.

The holder 18 holds the recording medium 99. The holder 18 includes a rotatable rotating shaft (a shaft) which passes through the winding core of the recording medium 99, and which holds the recording medium 99, and a support stage that supports the rotating shaft. The holder holds the recording medium 99 rotatably. The holder 18 serves as a holder according to the present disclosure.

The holder 18 is equipped with a motor to rotate the rotating shaft. The holder 18 rotates the rotating shaft at a number of rotations per an instructed unit time by driving this motor, winds off the holding recording medium 99, and feeds the recording medium 99 to the conveyer 11.

The conveyer 11 conveys the recording medium 99 wound off from the holder 18 along a conveying route, and supplies the recording medium 99 to the image forming device 20. The conveyer 11 serves as a conveyer according to the present disclosure. More specifically, the conveyer 11 includes a tension roller 12, a follower roller 13, a recording-medium setup unit 14, a recording-medium conveying roller pair 15, an automatic cutter 16, and a main-body-entry conveying roller pair 17.

The tension roller 12 is disposed right after the holder 18. The tension roller 12 controls so as not to have any slack in the recording medium 99 that is fed from the holder 18. The tension roller 12 is disposed so as to be movable in a vertical direction, and moves downwardly in the vertical direction due to force, such as a self-weight or a spring, to apply back tension to the recording medium 99 that is being conveyed. Hence, constant tension (tension) applied to the recording medium 99 is maintained, thereby stabilizing the conveyance of the recording medium 99.

The follower roller 13 is a roller which rotates, in conjunction with the recording medium 99 that is being conveyed, around the positionally-fixed rotating shaft. The follower roller 13 is disposed at the downstream side relative to the tension roller 12 in a conveying route. The follower roller 13 adjusts a conveying direction of the recording medium 99.

The recording-medium setup unit 14 is a unit prepared for an operator to restrict the supply position of the recording medium 99. The recording-medium setup unit 14 serves as a recording-medium setter according to the present disclosure. The recording-medium setup unit 14 includes a top cover engaged with a unit main body in a freely openable and closable manner, and a restriction guide that restricts a displacement of the recording medium 99 in a recording width direction. The top cover is integral with a member that holds an upper roller of the recording-medium conveying roller pair 15, and is opened and closed together with the recording-medium conveying roller pair 15 by the operator. The restriction guide is attached to the bottom plate of the main body of the recording-medium setup unit 14 in a freely slidable manner. The restriction guide serves as a recording-width detector for the recording medium 99.

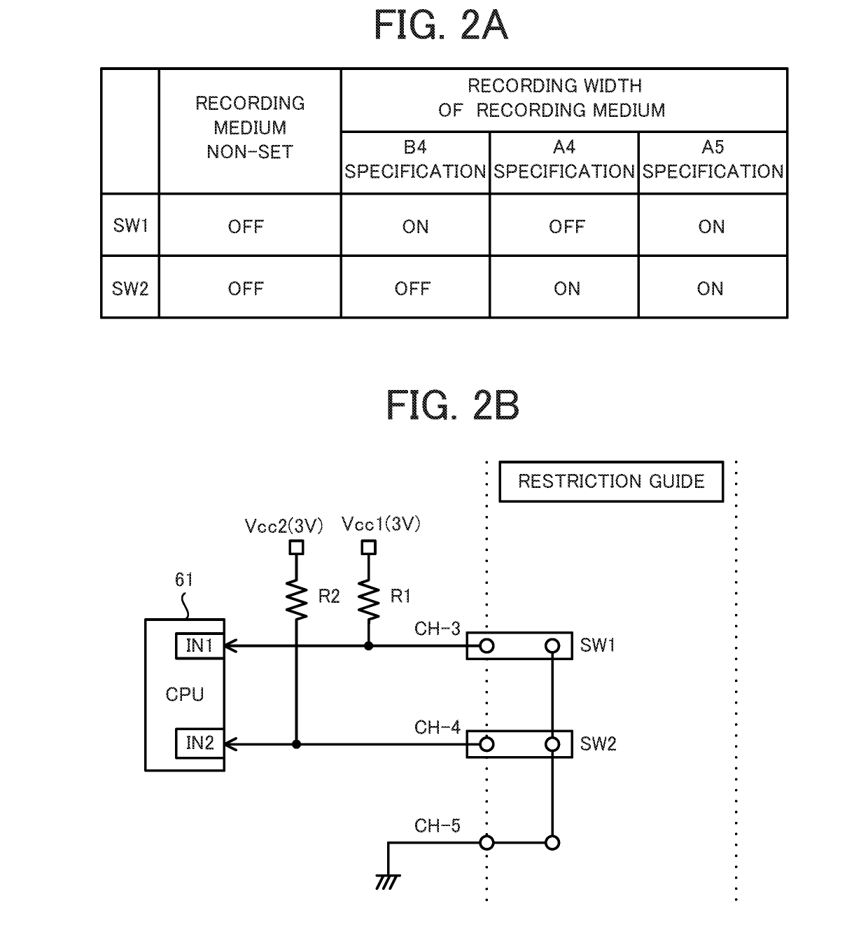

An explanation will be given of a structure to detect the recording width of the recording medium 99 with reference to FIG. 2. Note that the term recording width means a length of the recording medium 99 in a direction orthogonal to the supplying direction (conveying direction).

The recording medium 99 is wound off by the operator from the holder 18, and is placed on the bottom plate of the recording-medium setup unit 14. The operator slides the restriction guide so as not to cause a displacement of the recording medium 99 in the recording width direction, thereby restricting the conveying position of the recording medium 99. The recording-medium setup unit 14 includes switch elements SW1 and SW2 such as micro switch, reed switch or the like, disposed at the positions of the recording widths of recording media in respective formats. The ON/OFF states of the switch elements SW1 and SW2 are changed according to the sliding action of the restriction guide. FIG. 2A is a table illustrating respective ON/OFF states of the switch elements SW1 and SW2 when the recording medium 99 that has a recording width according to each predetermined format (B4, A4, A5) is restricted by the restriction guide or is not restricted. The image forming device 20 determines, based on a voltage level that changes according to the ON/OFF states of the switch elements SW1 and SW2, what recording width of the recording medium in the predetermined format the recording width of the recording medium 99 corresponds.

As illustrated in FIG. 2B, a signal line that connects the switch element SW1 with an IN port 1 (IN 1) of a CPU 61 of the image forming device 20 to be explained later is connected with a voltage source Vcc1 via a pull-up resistor R1. In addition, a signal line that connects the switch element SW2 with an IN port 2 (IN 2) of the CPU 61 is connected with a voltage source Vcc2 via a pull-up resistor R2. Still further, the switch element SW1 and the switch element SW2 are connected with each other by a ground wire that has one end grounded to the earth.

When, for example, no recording medium 99 is placed, and the restriction guide is restricting no recording medium 99, both of the switches SW1 and SW2 are in the OFF state, as illustrated in FIG. 2A. In this case, as illustrated in FIG. 2B, the IN ports IN 1 and IN 2 of the CPU 61 are subjected to a pull-up to a high (H) level voltage (3 V).

In addition, when, for example, the recording medium 99 with an A4 recording width is placed on the recording-medium setup unit 14, and the restriction guide is slid to restrict the recording medium 99, the switch element SW1 becomes the OFF state, while the switch element SW2 becomes the ON state. In this case, the IN port IN 1 of the CPU 61 is subjected to a pull-up, and the high (H) level voltage (3 V) is applied thereto. In addition, the IN port IN 2 of the CPU 61 is directly connected to the ground, and thus a low (L) level voltage (0 V) is applied thereto.

As explained above, the CPU 61 detects, based on the change in applied voltage, the size (recording width) of the recording medium 99 set up on the recording-medium setup unit 14.

Returning to FIG. 1, the recording-medium conveying roller pair 15 conveys the recording medium 99 set up on the recording-medium setup unit 14, to the subsequent conveying mechanism. The recording-medium conveying roller pair 15 is driven by a motor, holds the recording medium 99 set up on the recording-medium setup unit 14, and supplies the recording medium 99 to the automatic cutter 16 and the main-body-entry conveying roller pair 17.

The automatic cutter 16 cuts the back end of the recording medium 99 when the conveyance of the recording medium 99 with a necessary length for a process executed in the image forming device 20 completes.

The main-body-entry conveying roller pair 17 conveys the recording medium 99 cut out by the automatic cutter 16 to the image forming device 20. The main-body-entry conveying roller pair 17 is driven by a motor, holds and conveys the recording medium 99 supplied from the recording-medium conveying roller pair 15, and supplies this recording medium to the image forming device 20.

A specific explanation of operation will be given for setting up the recording medium 99 in the supply device 10. The operator winds off the recording medium 99 from the holder 18, let the wound-off recording medium to pass through the space below the tension roller 12, and holds this recording medium between the recording-medium conveying roller pair 15 through the recording-medium setup unit 14 in the opened condition. The operator closes the top cover of the recording-medium setup unit 14 in this condition. The set-up recording medium 99 is detected by an appropriate sensor. Upon detection of the recording medium 99, the recording-medium conveying roller pair 15 is rotated and driven. Hence, the recording medium 99 passes through the automatic cutter 16 and the main-body-entry conveying roller pair 17, and is conveyed to a standby position (home position) right before the entry to the image forming device 20.

Conversely, the winder 19 disposed on the supply device 10 rewinds and holds the recording medium 99 ejected from the image forming device 20. Like the holder 18, the winder 19 includes a rotatable rewinding shaft (a shaft) which passes through the winding core (tube) of the recording medium 99, and which holds the recording medium 99, and a support stage that supports the rewinding shaft. The winder 19 holds the recording medium 99 rotatably.

The winder 19 is equipped with a motor to rotate the rewinding shaft. The winder 19 rotates, by driving this motor, the rewinding shaft at a number of rotations per an instructed unit time. Hence, the winder 19 rewinds the recording medium 99 fed from the image forming device 20 through a follower roller 21.

The image forming device 20 is disposed on the top plate of the supply device 10. The image forming device 20 performs image formation on the recording medium 99 supplied from the supply device 10. The image forming device 20 is a label printer, for example. The image forming device 20 continuously forms an image of image data with a relatively large area on the recording medium 99 continuously fed from the supply device 10.

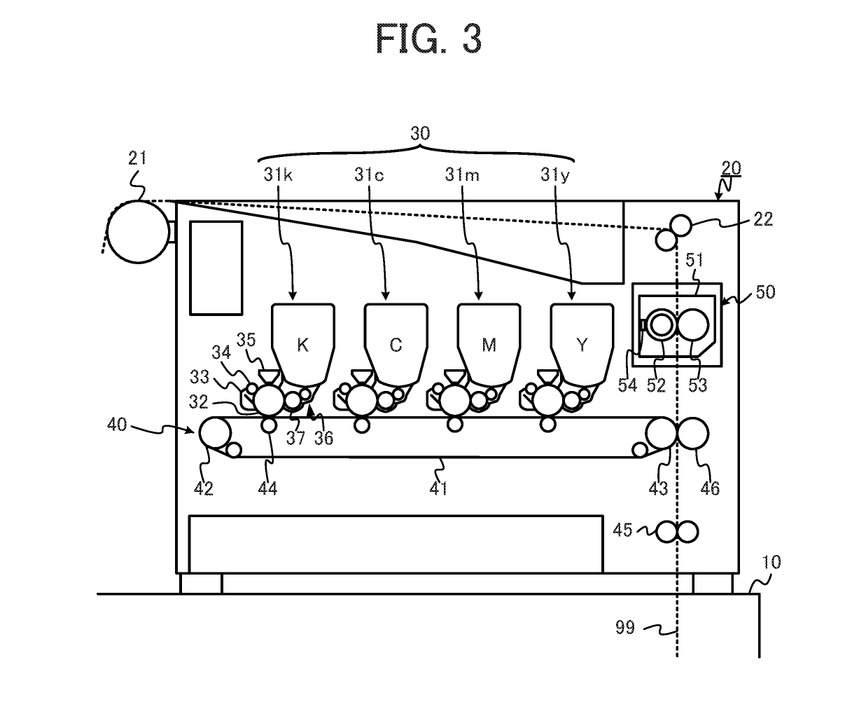

Next, with reference to FIG. 3, an internal structure of the image forming device 20 will be explained. In the following explanation, an electrophotographic, secondary-transfer and tandem color printer will be explained as an example image forming device 20. The image forming device 20 includes an image forming mechanism 30, an intermediate transfer belt unit 40 and a fixing mechanism 50.

The image forming mechanism 30 has a structure in which four image forming units 31 (31k, 31c, 31m and 31y) are arranged side by side in series. Among the four image forming units 31, the three image forming units 31c, 31m and 31y located at an upstream side (the right side on FIG. 3) form a color image with color toners of cyan (C), magenta (M) and yellow (Y), respectively. In contrast, the image forming unit 31k located at a downstream side (the left side on FIG. 3) forms a black-and-white image with black (K) toners mainly utilized for the dark portions, and the like of characters and images.

Each image forming unit 31 includes a photoreceptor drum 32 at a lower portion. The photoreceptor drum 32 has an outer circumference formed of an organic photoconductive material, for example Disposed near the photoreceptor drum 32 so as to surround the outer circumference thereof are a cleaner 33, an electrically-charged roller 34, an optical writing head 35, and a developing roller 37 of a developer 36.

The developer 36 includes a toner container which is disposed at an upper part and which contains any of the black (K), cyan (C), magenta (M) and yellow (Y) toners. The developer 36 includes a toner resupplying mechanism disposed at a middle part. The developer 36 also includes the above developing roller 37 disposed in an opening of a side face. In addition, the developer 36 includes a toner agitating member thereinside. The developing roller 37 includes a toner supplying roller that supplies toners, a doctor blade that restricts a toner layer on the developing roller 37 to have a constant layer thickness, and the like.

Although reference signs are given only to the image forming unit 31k for black (K) in FIG. 3, each image forming unit 31 has the same structure except the color of the toner contained in the toner container.

The intermediate transfer belt unit 40 includes an endless transfer belt 41, a driving roller 42 and a follower roller 43. The transfer belt 41 extends end to end in the horizontal direction illustrated in FIG. 3 in a flat loop shape in the image forming device 20 and at the substantial center thereof. The driving roller 42 circulates and moves the transfer belt 41 illustrated in FIG. 3 in a counterclockwise direction. The transfer belt 41 conveys the recording medium 99 to a transfer position so as to transfer (secondary transfer) a toner image directly transferred (primary transfer) on the belt face to the recording medium 99.

The intermediate transfer belt unit 40 includes four primary transfer rollers 44 within the loop of the transfer belt 41. The respective primary transfer rollers 44 correspond to the image forming units 31k, 31c, 31m and 31y. The primary transfer roller 44 includes a conductive foamed sponge to be pressed against the lower part of the outer circumference of the photoreceptor drum 32 via the transfer belt 31. The primary transfer roller 44 rotates at an instructed rotation cycle, and causes the transfer belt 41 to be in contact with the photoreceptor drum 32 and to be apart from the photoreceptor drum 32.

A standby conveying roller pair 45 receives the recording medium 99 conveyed from the supply device 10. The standby conveying roller pair 45 conveys the recording medium 99 received to a secondary transfer roller 46. The secondary transfer roller 46 is disposed so as to contact the follower roller 43 with a pressure via the transfer belt 41. The secondary transfer roller 46 performs, on the recording medium 99, secondary transfer of the toner image transferred on the belt face of the transfer belt 41. The secondary transfer roller 46 serves as a transferor according to the present disclosure.

The fixing mechanism 50 is disposed at a downstream side (upward side in FIG. 3) in the conveying direction of the recording medium 99 relative to the secondary transfer roller 46. The fixing mechanism 50 heats and melts the toners transferred on the recording medium 99, and causes the toners to which pressure is applied to be permeated in the recording medium 99. Hence, the toner image is fixed on the recording medium 99.

The fixing mechanism 50 retains a fixing unit 51 thereinside. The fixing unit 51 is attachable to and detachable from the image forming device 20. The fixing unit 51 serves as a fixing-unit attachment according to the present disclosure. The operator replaces the fixing unit 51 as needed. In addition, the fixing unit 51 is classified into multiple types according to a heating width of a first heater 57a to be explained later. In accordance with the recording width of the recording medium 99 set up on the recording-medium setup unit 14, the operator attaches the fixing unit of a corresponding type. The fixing unit 51 includes a fixing roller 52, a pressure applying roller 53 and thermistors 54.

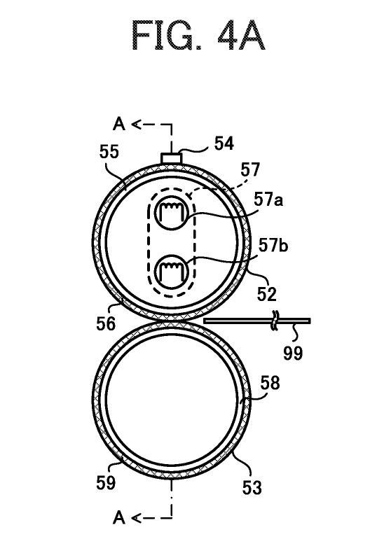

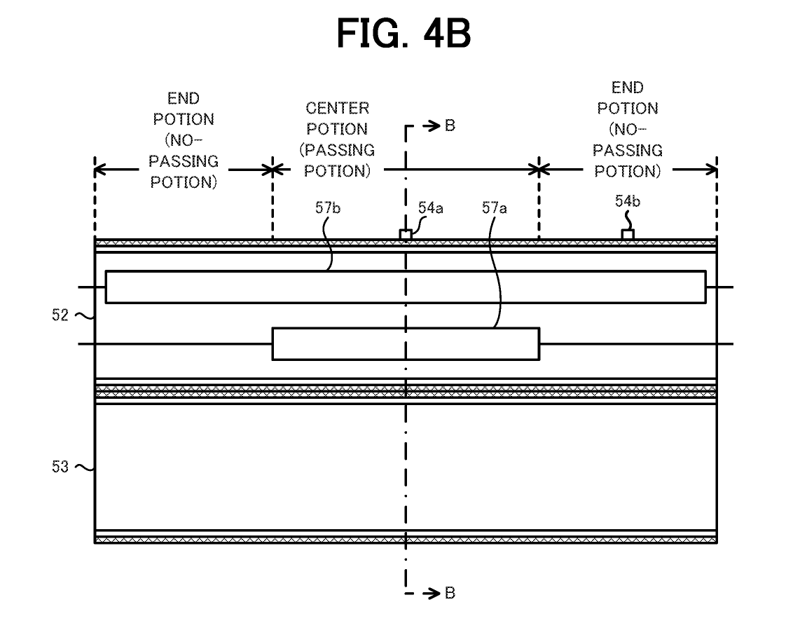

The fixing roller 52 heats the toners transferred on the recording medium 99. As illustrated in FIG. 4A, the fixing roller 52 includes a cylindrical core metal 55, and an elastic layer 56. The core metal 55 is formed of a metal. The elastic layer 56 is formed of, for example, a silicon rubber that covers the outer circumference of the core metal 55. In addition, the core metal 55 is a hollow, and heaters 57 that are heating elements are built in the hollow interior of the core metal 55. The fixing roller 52 is heated so as to be a temperature necessary to melt the toners by radiation heat from the heaters 57.

As illustrated in FIG. 4A and FIG. 4B, the fixing roller 52 includes the first heater 57a and a second heater 57b which have different lengths in the axial direction, and which are built in the fixing roller. The first heater 57a has a heating width capable of heating the recording medium 99 with a substantially equal length to one of any recording widths that are A4, B4, and A5 format. In addition, the second heater 57b has a heating width capable of heating the recording medium 99 with a substantially equal length to a recording width of A3 format. The CPU 61 selects either the first heater 57a or the second heater 57b to be utilized according to the recording width of the recording medium 99 set up on the recording-medium setup unit 14, supplies power to the selected heater 57, and heats the fixing roller 52. Note that the number of heaters 57 built in the fixing roller 52 is not limited to two, and may be equal to or greater than three.

As illustrated in FIG. 4B, the fixing roller 52 is divided into a center portion (passing portion) where the recording medium 99 passes, and end portions (no-passing portions) where no recording medium 99 passes. The center portion and the end portions vary depending on the recording width of the recording medium 99. FIG. 4B illustrates the center portion and the end portions divided when printing is performed on the recording medium 99 with a recording width that is conformed to the heating width of the first heater 57a. In this case, the condition in which the heating width of the heater 57 and the recording width of the recording medium 99 are conformed to each other means that the heating width of the heater 57 is slightly wider than the recording width of the recording medium 99, and the difference therebetween is substantially 10 mm.

The pressure applying roller 53 is a pressure applying member. The pressure applying roller 53 presses, against the recording medium 99, the toners in a melted condition by heating of the fixing roller 52. Hence, the toner image is fixed on the recording medium 99. As illustrated in FIG. 4A, the pressure applying roller 53 includes a cylindrical core metal 58 and an elastic layer 59. The core metal 58 is formed of a metal. The elastic layer 59 is formed of, for example, a silicon rubber, and covers the outer circumference of the core metal 58.

The pressure applying roller 53 is disposed so as to face the fixing roller 52. The pressure applying roller 53 is elastically supported by an elastic member like a spring. The pressure applying roller 53 is pushed against the fixing roller 52 so as to apply constant pressure thereto. Hence, a holding part where constant pressure is maintained is formed between the fixing roller 52 and the pressure applying roller 53. Accordingly, the recording medium 99 passing therethrough is heated and is subjected to pressure application, and thus the toner image is fixed on the recording medium 99. Note that a heater may be disposed in the pressure applying heater 53, and the temperature of the pressure applying heater 53 may be controlled as needed.

As illustrated in FIG. 4B, thermistors 54a, 54b are disposed at locations, respectively in a manner facing with the center portion and the one end portion of the fixing roller 52, and adjacent to the fixing roller 52. As illustrated in FIG. 4B, the thermistors 54a, 54b serve as a part of a temperature sensor that detects the temperature of the outer circumference of the fixing roller 52. The power supplied to the heaters 57 built in the fixing roller 52 is controlled according to the temperature detected by the thermistors 54a, 54b.

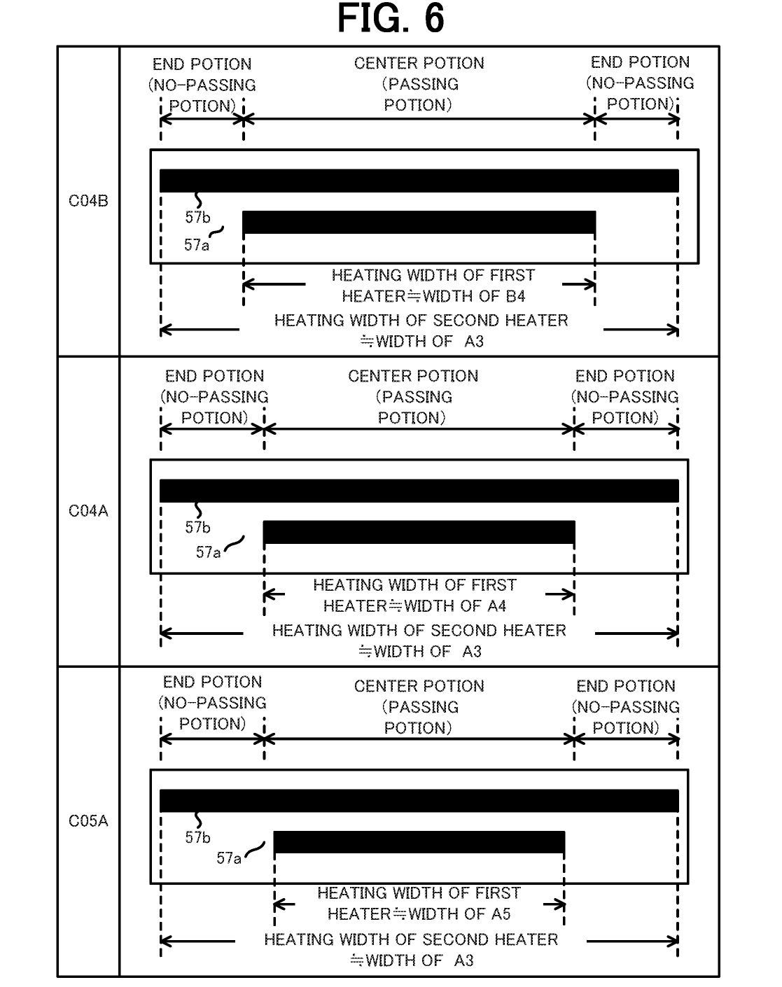

The fixing unit 51 is classified into multiple types as illustrated in FIG. 6 based on the combination of the heating width of the first heater 57a and that of the second heater 57b both built in the fixing roller 52. The first heater 57a has a heating width substantially equal to the respective recording widths of B4, A4, and A5 formats. The second heater 57b has a heating width substantially equal to the recording width of B3 format that is the maximum printable recording medium. In the first embodiment, the explanation will be given of an example case in which the fixing unit 51 is classified into three types, but the number of types is not limited to this number, and the types of the fixing unit 51 may be defined so as to be conformed to a larger number of recording widths of recording media. In addition, the second heater 57b may also have different heating widths from one another.

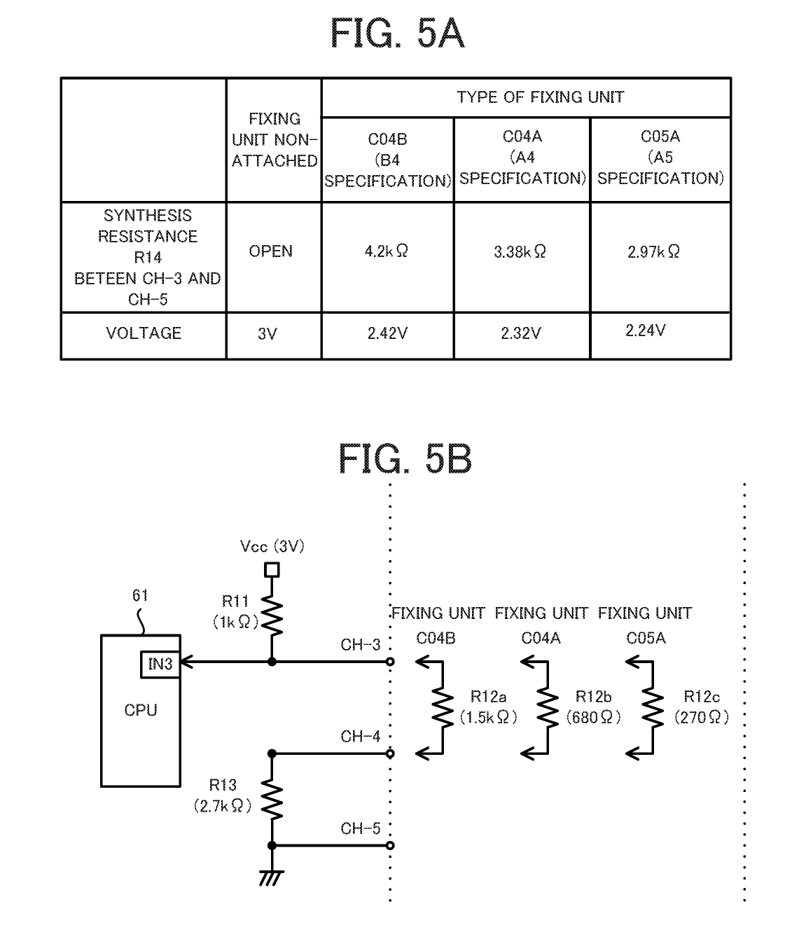

In this case, an explanation will be given of a structure to determine an attached or detached condition of the fixing unit 51, and the type of the attached fixing unit 51 with reference to FIG. 5 and FIG. 6. The fixing unit 51 includes resistor elements R12 that have different resistance values according to the type classified based on the heating width of the first heater 57a. As illustrated in FIG. 5B, for example, fixing units of types C04B, C04A and C05A have resistor elements that are R12a, R12b and R12c, respectively. The resistor elements R12a, R12b and R12c have respective resistance values that are 1.5 kΩ, 680Ω and 270Ω FIG. 5A is a table that indicates a synthesis resistance R14 of the resistor element R12 with a pull-down resistor R13 of the supply device 10, and a voltage value applied to an IN port 3 (IN 3) of the CPU 61.

When no fixing unit 51 is attached to the image forming device 20, the IN port IN 3 of the CPU 61 of the image forming device 20 is subjected to a pull-up via the pull-up resistor R11 of the image forming device 20, and a high (H) level voltage (3 V) is applied. The image forming device 20 becomes able to determine the attached or detached condition of the fixing unit 51 by detecting the voltage level applied to the IN port 3.

Conversely, when the fixing unit 51 is attached to the image forming device 20, a voltage dividing ratio accomplished by the pull-up resistor R11, and the synthesis resistance R14 of the resistor element R12 with the pull-down resistor R13 changes according to the type of the fixing unit 51 (resistor element R12) to be attached. Hence, the voltage level applied to the IN port 3 (IN 3) of the image forming device 20 also changes according to the type of the fixing unit 51 to be attached. The image forming device 20 becomes able to determine the type of the attached fixing unit 51 by detecting the voltage level applied to the IN port 3.

When, for example, the fixing unit 51 of a type C05A is attached to the image forming device 20, the resistance value of the synthesis resistance R14 of the resistor (270Ω) of this fixing unit 51 with the pull-down resistor (2.7 kΩ) of the image forming device 20 becomes 2.97 kΩ. In this case, since the voltage applied to the IN port 3 of the image forming device 20 is a divided voltage by the pull-up resistor R11 (1 kΩ) and the synthesis resistance R14, such a voltage becomes 2.24 V.

As explained above, based on the applied voltage, the image forming device 20 detects the type of the attached fixing unit 51. Note that the resistor element of the fixing unit 51 is not limited to one that are connected to CH-3 and CH-4. For example, the resistor element of the fixing unit 51 may be structured so as to connect CH-3 with CH-4, and be connected in parallel with the pull-down resistor R13. According to this structure, even if the type of the fixing unit 51 is in a broad range, the image forming device becomes able to determine the type of the fixing unit 51, based on the voltage value applied to the CPU 61.

Returning to FIG. 3, an ejecting roller pair 22 is disposed at the further downstream side relative to the fixing mechanism 50. The ejecting roller pair 22 ejects, from the fixing mechanism 50, the recording medium 99 on which the toner image is fixed. The ejecting roller pair 22 ejects the recording medium 99 to an ejecting tray formed on the upper face of the image forming device 20. The recording medium 99 ejected through the ejecting roller pair 22 is supplied to the winder 19 through the follower roller 21 disposed at the side portion of the image forming device 20.

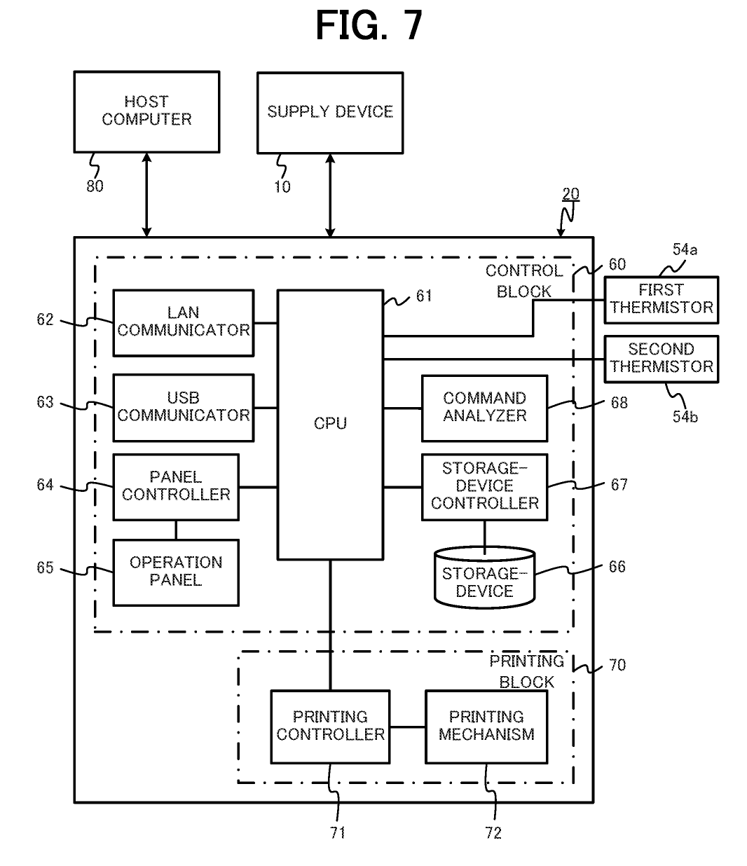

Next, with reference to FIG. 7, an explanation will be given of a structure with respect to a control of the image forming device 20. The image forming device 20 is connected with a host computer 80 and the supply device 10 one another via a network like a Local Area Network (LAN) or a Universal Serial Bus (USB).

The image forming device 20 includes a control block 60 and a printing block 70. More specifically, the control block 60 includes the CPU 61, a LAN communicator 62, a USB communicator 63, a panel controller 64, an operation panel 65, a storage device 66, a storage-device controller 67, and a command analyzer 68. In addition, the printing block 70 includes a printing controller 71, and a printing mechanism 72.

The CPU 61 is connected with respective components of the image forming device 20 via a system bus that is a transmission route to transmit instructions and data, and controls the operations of the respective components of the image forming device 20. The CPU 61 utilizes a Read Only Memory (ROM) and a Random Access Memory (RAM) as work memories, reads various programs like a system software stored in the ROM and the storage device 66, and executes the read program as needed.

In addition, signals (temperature signals) indicating temperatures measured by the thermistors 54a, 54b are supplied to the CPU 61.

The LAN communicator 62 and the USB communicator 63 communicate with an external device. The LAN communicator 62 performs communication via the LAN. The USB communicator 63 performs communication via the USB. The CPU 61 communicates with the host computer 80 via the LAN communicator 62 or the USB communicator 63. The CPU 61 receives, via the LAN communicator 62 or the USB communicator 63, a printing job transmitted from the host computer 80. In addition, the CPU 61 transmits, via the LAN communicator 62 or the USB communicator 63, various kinds of information on the image forming device 20 to the host computer 80. Still further, the CPU 61 communicates the supply device 10 via the LAN communicator 62 or the USB communicator 63. The CPU 61 receives an output signal by a detection element (sensor) disposed in the recording-medium setup unit 14, and detects the recording width of the recording medium 99, based on the received output signal.

The panel controller 64 is connected with the operation panel 65. The operation panel 65 includes a display panel like a Liquid Crystal Display (LCD), and an input device with various operation buttons, and the like. The panel controller 64 displays, under the control of the CPU 61, various images, characters, symbols and the like on the operation panel 65. In addition, the panel controller 64 accepts various operations given by the user and input to the operation panel 65. The panel controller 64 supplies, to the CPU 61, operation signals corresponding to various accepted operations, respectively. Note that the operation panel 65 may be a device like a touch panel (touch screen) with touch-switch function, that has a combination of an input function and a display function.

The storage device 66 is a non-volatile memory, for example an Electrically Erasable Programmable ROM (EEPROM), a Hard Disk Drive (HDD) or the like. The storage device 66 stores various programs and various data necessary for the image forming device 20 to operate.

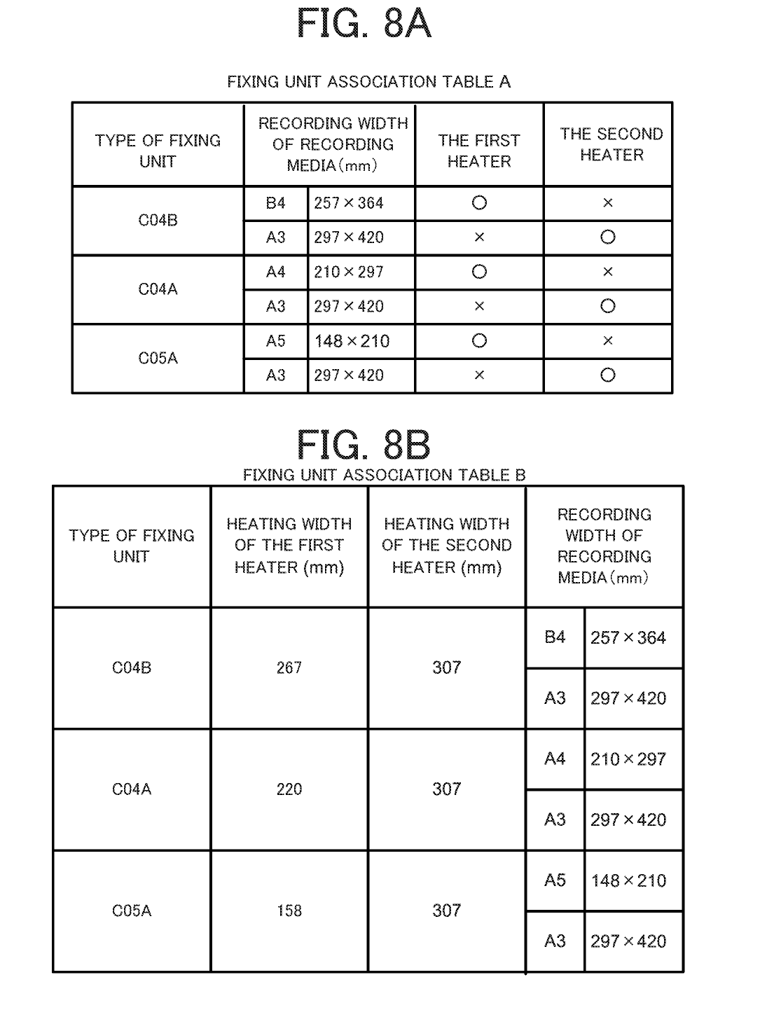

The storage device 66 stores a fixing-unit association table A illustrated in FIG. 8A. The fixing-unit association table A contains the type of the fixing unit 51, the recording width of the recording medium, and the selection information on either the first heater 57a or the second heater 57b, in association one another. The type of the fixing unit 51 is classified according to the heating width of the first heater 57a built in the fixing roller 52. The recording width of the recording medium indicates the recording width (width×length) of the recording medium in a format conformed to the heating width of the first heater 57a. The selection information on the heater 57 is information that indicates which one of the first heater 57a or the second heater 57b is selectable.

In addition, the storage device 66 also stores a fixing-unit association table B illustrated in FIG. 8B. The fixing-unit association table B contains the type of the fixing unit 51, the heating width of the first heater 57a and that of the second heater 57b, and the recording width of the recording medium, in association one another. The type of the fixing unit 51 is classified according to the heating width of the first heater 57a. The heating width of the first heater 57a is wider than the recording width of any of A4, B4, and A5 format by substantially 10 mm, and covers the full recording width of each recording medium. The recording width of the recording medium indicates the recording width (width×length) of the recording medium in a format conformed to the heating width of the first heater 57a.

The storage-device controller 67 controls, under the control of the CPU 61, writing of data into the storage device 66, and reading of data stored in the storage device 66.

The command analyzer 68 analyze, under the control of the CPU 61, commands contained in print data that is transmitted from the host computer 80. The command analyzer 68 converts, for each of black (K), magenta (M) cyan (C), and yellow (Y), print data into image data in a bitmap format. The command analyzer 68 develops the converted bitmap image data in a corresponding memory area in a frame memory, for each of black (K), magenta (M), cyan (C), and yellow (Y). The image data developed in the frame memory is output to the printing controller 71.

The printing controller 71 controls, under the control of CPU 61, the printing mechanism 72 that includes the image forming mechanism 30, the intermediate transfer belt unit 40, and the fixing mechanism 50. The printing controller 71 executes a printing process in accordance with the image data created by the command analyzer 68. For example, the printing controller 71 controls the vertical movement of the intermediate transfer belt unit 40, the rotations and actuations of the transfer belt, the driving roller 42, standby conveying roller pair 45, ejecting roller pair 22 and the like, and the voltage application to the rotating and driving systems and the like, the voltage application to the heater 57 of the fixing mechanism 50 and the like.

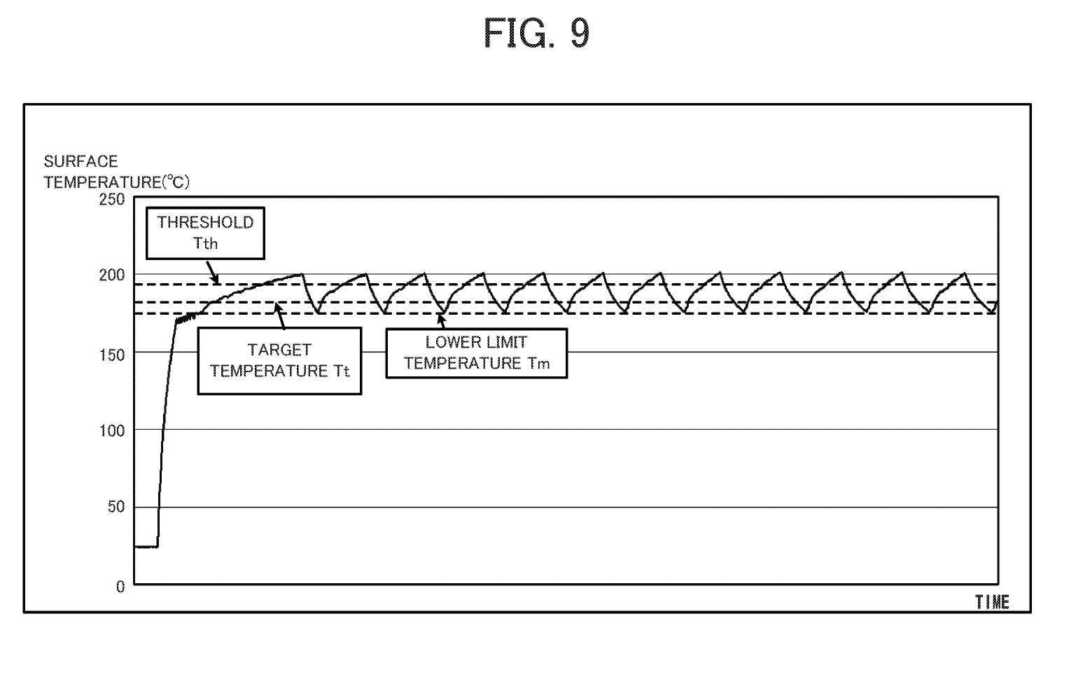

Next, with reference to FIG. 9, an explanation will be given of a transition in a surface temperature of the end portion (no-passing portion) of the fixing roller 52 where no recording medium 99 passes. When the image forming device 20 is activated, the CPU 61 heats the heater 57 at the maximum output until the detection temperature of the thermistor 54a reaches a target temperature Tt (for example, 180° C.) that is a necessary temperature to melt the toners. The CPU 61 performs a feedback control on the amount of generated heats by the heater 57 so as to maintain the target temperature Tt after the detection temperature of the thermistor 54a reaches the target temperature Tt. For example, the CPU 61 performs a Proportional Integral Derivative (PID) control to control the power to be supplied to the heater 57, based on an errorvalue e (e=Tr−Tt) between a temperature Tr of the fixing roller 52 detected by the thermistor 54a and the preset target temperature Tt.

As explained above, the surface temperature of the center portion (passing portion) of the fixing roller 52 where the recording medium 99 passes is substantially maintained at the target temperature Tt by the PID control. In contrast, the surface temperature of the end portion (no-passing portion) of the fixing roller 52 where no recording medium 99 passes becomes higher than that of the center portion (passing portion) since such an end portion stores heat without allowing the recording medium 99 to absorb the heat.

The surface temperature of the end portion of the fixing roller 52 rises until reaching the target temperature Tt like the center portion, after the image forming device 20 is activated. After the detection temperatures of the thermistors 54a, 54b reach the target temperature Tt, the CPU 61 starts a printing operation. The surface temperature of the end portion of the fixing roller 52 gradually rises after the printing operation starts. When the detection temperature of the thermistor 54b exceeds a preset threshold Tth (for example, 190° C.) and the end portion becomes an overheated condition, the CPU 61 terminates the power supply to the heater 57 in the fixing roller 52, and once suspends the printing operation. When the surface temperature of the end portion of the fixing roller 52 falls to a lower limit temperature Tm (for example, 175° C.) necessary to melt the toners, the CPU 61 restarts the power supply to the heater 57 and restarting the printing operation thereby. As explained above, the CPU 61 instructs a suspension and a restart of the printing operation according to a change of surface temperature of the end portion. Respective values of the target temperature Tt, lower limit temperature Tm, and threshold Tth are stored in, for example, the EEPROM or the HDD beforehand.

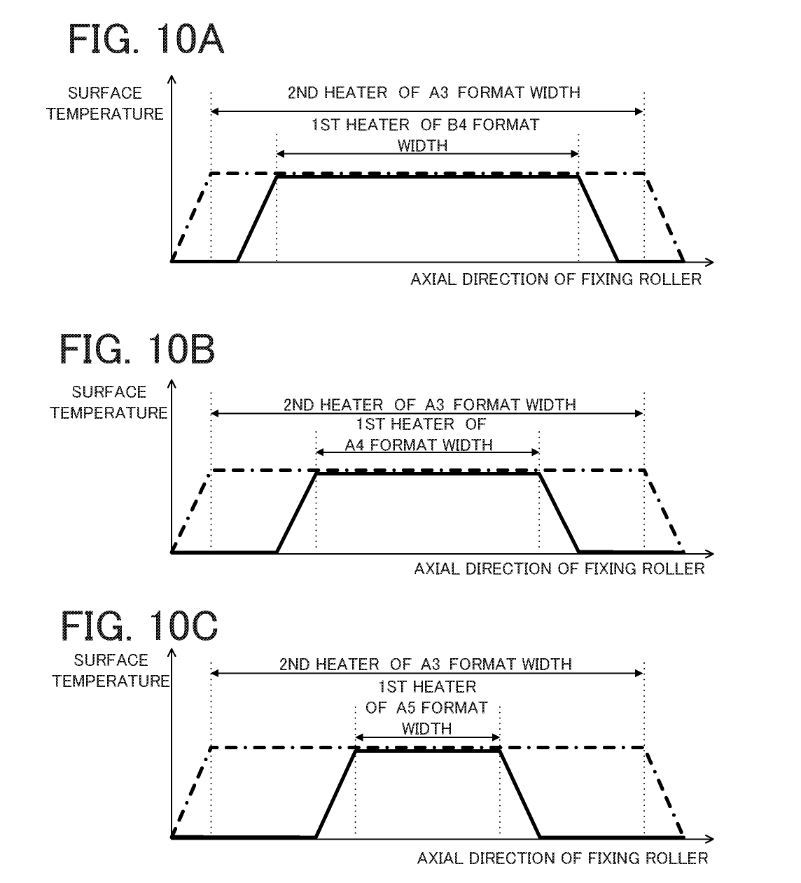

Next, with reference to FIG. 10, an explanation will be given of a surface temperature distribution of the fixing roller 52 when the fixing unit 51 corresponding to the recording width of the recording medium 99 is utilized. Solid lines in FIGS. 10A to 10C respectively indicate surface temperature distributions of the fixing roller 52 when the first heater 57a that has conformed heating widths to the widths of B4, A4, and A5 formats, respectively, is utilized. Conversely, dashed lines in FIGS. 10A to 10C indicate a surface temperature distribution of the fixing roller 52 when the second heater 57b that has a conformed heating width to the width of A3 format is utilized, and a continuous printing operation is performed.

As illustrated in FIGS. 10A to 10C, when the fixing roller 52 is heated by the first heater 57a, the surface temperature of the fixing roller 52 is a high temperature within the heating width of the first heater 57a, but decreases toward the external side. When the fixing roller 52 is heated by the second heater 57b, likewise, the surface temperature of the fixing roller 52 is a high temperature within the heating width of the second heater 57b, but decreases toward the external side.

As explained above, when a continuous printing is performed using the fixing unit 51 that has the heater 57 with a conformed heating width to the recording width of the recording medium 99, the temperature of the end portion (no-passing portion) of the fixing roller 52 where no recording medium 99 passes does not rise beyond that of the center portion (passing portion) where the recording medium 99 passes. Hence, the possibility that the end portion of the fixing roller 52 has the surface temperature rising and becomes an overheated condition is little.

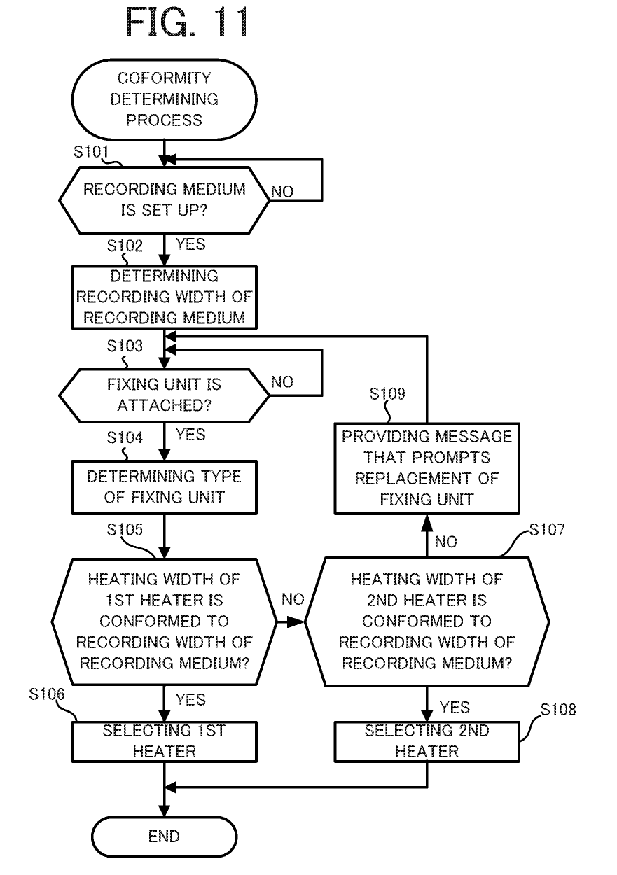

Next, with reference to the flowchart of FIG. 11, an explanation will be given of a conformity determining process executed by the image processing device 20. Note that, in response to the creation of a print job by a loaded printing command, the CPU 61 of the image processing device 20 starts the process illustrated in FIG. 11. The CPU 61 serves as a conformity determiner according to the present disclosure in this case.

First, the CPU 61 determines (step S101) whether or not the recording medium 99 is set up on the recording-medium setup unit 14. When the recording medium 99 is set and the top cover of the recording-medium setup unit 14 is closed, an output signal by an appropriate sensor is transmitted to the image forming device 20 via the communicator of the supply device 10. When receiving the output signal from the supply device 10, the CPU 61 determines that the recording medium 99 is set up on the recording-medium setup unit 14.

When determining (step S101: YES) that the recording medium 99 is set up on the recording-medium setup unit 14, the CPU 61 determines (step S102) the recording width of the recording medium 99. Based on the values of the voltages applied to the IN port 1 and the IN port 2, the CPU 61 determines the size (recording width) of the recording medium 99. The CPU 61 serves as a recording-medium-type reader according to the present disclosure in this case.

Conversely, when receiving no output signal from the supply device 10, the CPU 61 determines (step S101: NO) that the recording medium 99 is not set up yet on the recording-medium setup unit 14. In this case, the CPU 61 returns the process to the step S101. That is, until determining that the recording medium 99 is set up on the recording-medium setup unit 14 (until receiving the output signal from the supply device 10), the CPU 61 repeats the process in the step S101.

After determining the size (recording width) of the recording medium 99 in the step S102, the CPU 61 determines (step S103) whether or not the fixing unit 51 is attached to the image forming device 20. Based on the value of the voltage applied to the IN port 3, the CPU 61 determines whether or not the fixing unit 51 is attached.

When determining (step S103: YES) that the fixing unit 51 is attached, the CPU 61 determines (step S104) the type of the fixing unit 51. Like the process in the step S103, based on the value of the voltage applied to the IN port 3, the CPU 61 determines the heating width of the fixing unit 51. The CPU 61 serves as a fixing-unit-type reader according to the present disclosure in this case.

Conversely, when determining (step S103: NO) that the fixing unit 51 is not attached yet, the CPU 61 returns the process to the step S103 and stands by until the fixing unit 51 is attached.

When completing the process in the step S104, the CPU 61 determines (step S105) whether or not the heating width of the first heater 57a specified based on the type of the fixing unit 51 is conformed to the recording width of the recording medium 99. The CPU 61 looks up the fixing-unit association table A stored in the storage device 66, and checks whether or not the size (recording width) of the recording medium 99 determined in the step S102 is associated with the type of the fixing unit 51 determined in the step S104. Hence, the CPU makes a determination on whether or not the heating width of the first heater 57a is conformed to the recording width of the recording medium 99.

When determining (step S105: YES) that the heating width of the first heater 57a is conformed to the recording width of the recording medium 99, the CPU 61 selects the first heater 57a as the heater 57 to be utilized (step S106), and ends the process. Note that the CPU 61 may provide a message to the effect that the type of the attached fixing unit 51 is conformed to the recording width of the recording medium 99 set up on the recording-medium setup unit 14 before ending the process. The CPU 61 serves as a message provider according to the present disclosure in this case.

When determining (step S105: NO) that the heating width of the first heater 57a is not conformed to the recording width of the recording medium 99, the CPU 61 determines (step S107) whether or not the heating width of the second heater 57b is conformed to the recording width of the recording medium 99. The CPU 61 looks up the fixing-unit association table B illustrated in FIG. 8B, and when a difference between the heating width of the second heater 57b and the recording width of the recording medium 99 is equal to or less than 10 mm, the CPU determines as conformance. When determining (step S107: YES) that the heating width of the second heater 57b is conformed to the recording width of the recoding medium 99, the CPU 61 selects the second heater 57b as the heater 57 to be utilized (step S108), and ends the process.

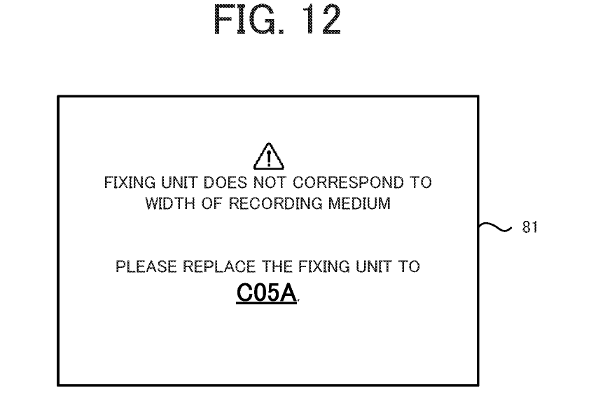

Conversely, when determining (step S107: NO) that the heating width of the second heater 57b is not conformed to the recording width of the recording medium 99, the CPU 61 looks up the fixing-unit association table B illustrated in FIG. 8B, and searches the heater 57 that has a conformed heating width to the recording width of the recording medium 99. The CPU 61 specifies the type of the fixing unit 51 based on a search result. In this case, the CPU 61 displays (step S109), on the operation panel 65 by controlling the panel controller 64, a message that prompts a replacement of the attached fixing unit 51 with the fixing unit 51 of a conformance type to the recording width of the recording medium 99 as illustrated in FIG. 12.

When ending the process in the step S109, the CPU 61 returns the process to the step S103 and repeats the processes in the steps S103 to S105. That is, until selecting either the first heater 57a or the second heater 57b as the heater 57 to be utilized, the CPU 61 keeps displaying a message screen 81 illustrated in FIG. 12 on the operation panel 65.

After this process ends and other initializing processes end, the print job generated according to the printing command received from the host computer 80 is executed.

As explained above, according to this first embodiment, based on the condition in which the fixing unit 51 conformance to the recording width of the set recording medium 99 is attached to the image forming device 20, the print job is executed. Hence, printing is performed using the heater 57 that has a substantially equal heating width to the recording width of the recording medium 99, and thus the end portion of the fixing roller 52 is prevented from having a temperature exceeding the threshold Tth and becoming an overheated condition.

### Second Embodiment

The printing device 100 of the first embodiment provides a message that prompts a replacement of the fixing unit 51 when the heating width of the first heater 57a and that of the second heater 57b are not conformed to the recording width of the recording medium 99. However, a case may occur in practice in which the operator has no choice to carry out a continuous printing under a circumstance that, for example, the conformed fixing unit 51 with the recording width of the recording medium 99 is not ready.

An explanation will be given below of a printing device 100 which utilizes the attached fixing unit 51 and which provides information to improve a printing efficiency, even if the type of the attached fixing unit 51 is not compatible with the recording width of the recording medium 99.

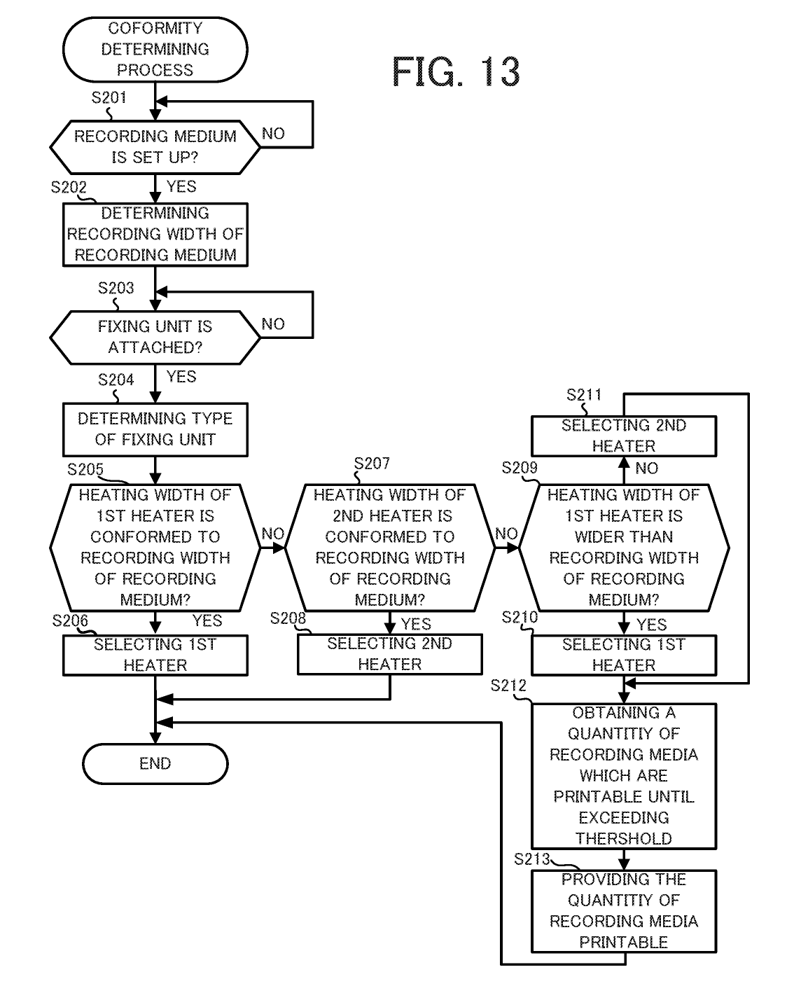

With reference to the flowchart of FIG. 13, a conformity determining process executed when the fixing unit 51 not conformed to the recording width of the recording medium 99 is utilized to perform a printing will be explained. In response to generation of a print job by the casted printing command, the CPU 61 of the image processing device 20 starts the process illustrated in FIG. 13. Note that the steps S201 to S208 in the flowchart of FIG. 13 are the same processes as those of the steps S101 to S108 in the flowchart of FIG. 11. Hence, the explanation will be simplified or omitted below.

After determining the recording width of the recording medium 99 and the type of the fixing unit 51 through the processes in the steps S201 to S204, the CPU 61 determines (step S205) whether or not the heating width of the first heater 57a specified based on the type of the fixing unit 51 is conformed to the recording width of the recording medium 99. When determining (step S205: NO) as not conformance, the CPU 61 determines (step S207) whether or not the heating width of the second heater 57b is conformed to the recording width of the recording medium 99 set up on the recording-medium setup unit 14.

When determining (step S207: NO) that the heating width of the second heater 57b is not conformed to the recording width of the recording medium 99, the CPU 61 determines (step S209) whether or not the heating width of the first heater 57a is wider than the recording width of the recording medium 99. This is to avoid a technical trouble that a part of a toner image is not fixed on the recording medium 99 due to the insufficient heating width of the first heater 57a.

When determining (step S209: YES) that the heating width of the first heater 57a is wider than the recording width of the recording medium 99, the CPU 61 selects (step S210) the first heater 57a as the heater 57 to be utilized. Next, the CPU 61 obtains (step S212) a quantity (length, number of recording media) of the recording media 99 which are printable until a temperature of a preset portion of the fixing unit 51, in this case, a temperature of the end portion of the fixing roller 52 (a portion subjected to a temperature measurement by the thermistor 54b) exceeds a threshold Tth. That is, the printable quantity without thermally damaging the fixing unit 51 is obtained. As for the quantity of the printable recording media 99, temperature rise characteristics of the fixing roller 52 are taken into consideration. More specifically, a time until the temperature of the end portion of the fixing roller 52 exceeds the threshold Tth is calculated, and the quantity of printable recording media 99 within this time is calculated. In addition, the quantity of printable recording media 99 may be obtained beforehand by a test, and for example, such a quantity may be stored in the EEPROM or the HDD. The CPU 61 serves as a recording-medium-quantity obtainer according to the present disclosure in this case.

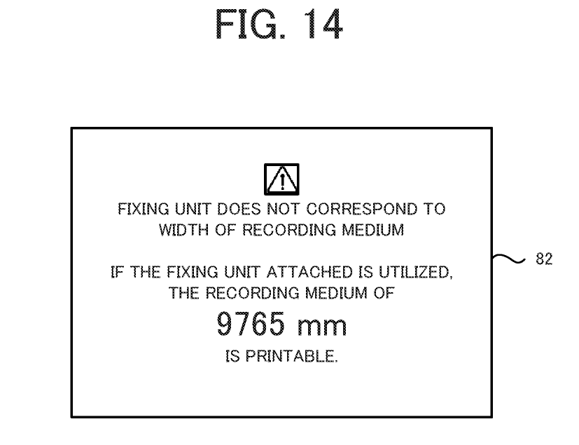

Next, the CPU 61 displays (step S213), on the operation panel 65 by controlling the panel controller 64, a message screen 82 illustrated in FIG. 14. The message screen 82 shows a message to the effect that the attached fixing unit 51 is not conformed to the recording width of the recording medium 99, and the quantity of printable recording media 99. This allows the operator to know the quantity of recording media 99 which are printable until the printing operation is suspended. After ending the process in the step S213, the CPU 61 ends the conformity determining process.

Conversely, when determining (step S209: NO) that the heating width of the first heater 57a is narrower than the recording width of the recording medium 99, the CPU 61 selects (step S211) the second heater 57b as the heater 57 to be utilized. After ending the process in the step S211, the CPU 61 shifts the process to the step S212.

As explained above, according to this second embodiment, the first heater 57a is utilized when the heating width of the first heater 57a built in the attached fixing unit 51 is wider than the recording width of the recording medium 99 set up on the recording-medium setup unit 14. At this time, the quantity of printable recording media 99 until the temperature of the end portion of the fixing roller 52 where no recording medium 99 passes exceeds the threshold is obtained and provided to the operator. This enables the operator to confirm the quantity of printable recording media 99 beforehand, and to select the detail of the printing operation according to the quantity of the recording media 99. Hence, a reduction of a printing efficiency is preventable.

### Modified Example

The embodiments of the present disclosure were explained above, but the above embodiments are merely examples, and the application range of the present disclosure is not limited to those examples. That is, various modifications can be made to the embodiments of the present disclosure, and all embodiments that can be carried out according to the present disclosure are within the scope and spirit of the present disclosure.

For example, according to the above embodiments, the explanation was given of fixing unit 51 that includes the fixing roller 52, the pressure applying roller 53 and the thermistors 54, as an example. However, the structure of the fixing unit 51 is not limited to this example, and the fixing unit may be a so-called fixing belt scheme that employs a heating roller built with an internal heater instead of the fixing roller, and an additional fixing belt which is tensioned between the fixing roller and the heating roller. In this case, the fixing belt and the fixing roller have respective center portions (passing portions) and end portions (no-passing portions), but by adjusting the heating width of the internal heater of the heating roller that is a heating source, the same effects as those of the above embodiments are accomplishable.

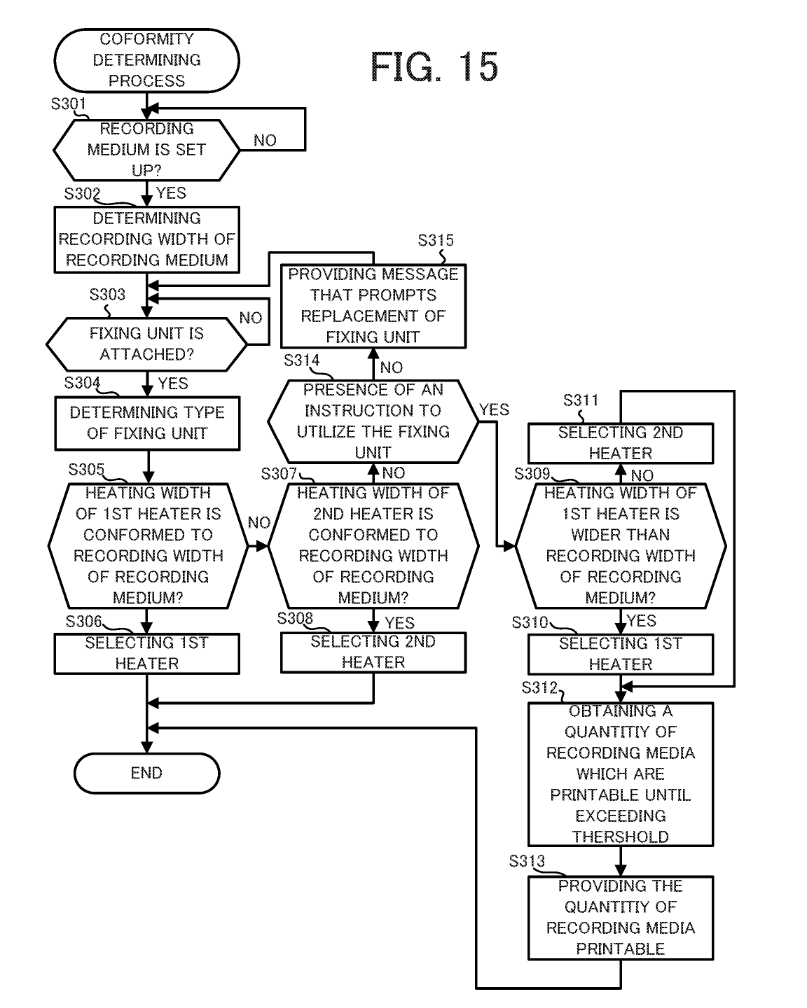

In addition, according to the second embodiment, when both of the heating width of the first heater 57a and that of the second heater 57b are determined as not conformance to the recording width of the recording medium 99, whether or not the heating width of the first heater 57a is wider than the recording width of the recording medium 99 is determined, and based on this determination result, the first heater 57a or the second heater 57b is selected. When, however, both of the heating width of the first heater 57a and that of the second heater 57b are determined as not conformance to the recording width of the recording medium 99, as illustrated in FIG. 15, a presence/absence of an instruction to utilize the attached fixing unit 51 may be determined (step S314), and when a determination is made (step S314: YES) that there is such an instruction, the first heater 57a or the second heater 57b may be selected (steps S309 to S311). In addition, when a determination is made (step S314: NO) that there is no such instruction to utilize the attached fixing unit 51, a message that prompts a replacement of the fixing unit may be provided (step S315). As explained above, when both of the heating width of the first heater 57a and that of the second heater 57b are determined as not conformance to the recording width of the recording medium 99, as for whether or not to utilize the attached fixing unit 51, the operator's intention can be reflected.

Note that, needless to say, a printing device that includes the structure to realize the functions according to the present disclosure beforehand can be provided, and a conventional information device may be caused to function as the printing device according to the present disclosure by applying a program. That is, a program to realize each functional structure of the printing device 100 exemplified in the above embodiments may control a conventional information device to function as explained above. In addition, a control method according to the present disclosure can be carried out using the printing device.

Still further, how to apply such a program is optional. For example, the program is applicable in a manner stored in a computer-readable recording medium, such as a flexible disk, a Compact Disc (CD)-ROM, a Digital Versatile Disc (DVD)-ROM, or a memory card. Moreover, the program may be superimposed on carrier waves, and may be applied via a communication medium like the Internet. For example, the program may be posted on a Bulletin Board System (BBS) over a communication network for an application to an information device. Next, this program may be started, and under the control of an Operating System (OS), the program may be executed like other application programs to accomplish a structure that executes the above processes.

The preferred embodiments of the present disclosure were explained above, but the present disclosure is not limited to such specific embodiments, and the present disclosure covers the invention set forth in appended claims and the equivalent range thereto.

This application claims the priority based on Japanese Patent Application No. 2013-196095 filed on Sep. 20, 2013, the entire contents of which are herein incorporated in this specification by reference.

### REFERENCE SIGNS LIST

10 Supply device
11 Conveyer
12 Tension roller
13 Follower roller
14 Recording-medium setup unit
15 Recording-medium conveying roller pair
16 Automatic cutter
17 Main-body-entry conveying roller pair
18 Holder
19 Winder
20 Image forming device
21 Follower roller
22 Ejecting roller pair
30 Image forming mechanism
31 (31k, 31c, 31m, 31y) Image forming unit
32 Photoreceptor drum
33 Cleaner
34 Electrically-charged roller
35 Optical writing head
36 Developer
37 Developing roller
40 Intermediate transfer belt unit
41 Transfer belt
42 Driving roller
43 Follower roller
44 Primary transfer roller
45 Standby conveying roller pair
46 Secondary transfer roller
50 Fixing mechanism
51 Fixing unit
53 Pressure applying roller
54 Thermistor
54a First thermistor
54b Second thermistor
55 Core metal
56 Elastic layer
57 Heater
57a First heater
57b Second heater
58 Core metal
59 Elastic layer
60 Control block
61 CPU
62 LAN communicator
63 USB communicator
64 Panel controller
65 Operation panel
66 Storage device
67 Storage-device controller
68 Command analyzer
70 Printing block
71 Printing control block
72 Printing mechanism
80 Host computer
81, 82 Message screen
99 Recording medium
100 Printing device

1. A printing device comprising:
a recording-medium-type reader that reads a type of a recording medium;
a fixing-unit attachment that selectively attaches any one of a plurality of fixing units, the plurality of fixing units being different types from one another; and
a conformity determiner that determines whether or not the type of the fixing unit attached in the fixing-unit attachment is conformed to the type of the recording medium read by the recording-medium-type reader.

2. The printing device according to claim 1, further comprising a message provider that provides a message according to a determination result by the conformity determiner,
wherein when the conformity determiner determines as not conformance, the message provider provides a message that prompts a replacement of the fixing unit with a type conformed to the type of the recording medium read by the recording-medium-type reader.

3. The printing device according to claim 1, further comprising:
a recording-medium setter that selectively sets up any one of a plurality of the recording media, the plurality of recording media being different types from one another; and
a fixing-unit-type reader that reads a type of the fixing unit attached in the fixing-unit attachment,
wherein:
the type of the recording medium is a recording width of the recording medium;
the recording-medium-type reader reads the recording width of the recording medium set up on the recording-medium setter;
the type of the fixing unit is a heating width of a heater in the fixing unit;
the fixing-unit-type reader reads the heating width of the heater in the fixing unit attached in the fixing-unit attachment; and
the conformity determiner determines as conformance when a difference between the heating width of the heater in the fixing unit read by the fixing-unit-type reader and the recording width of the recording medium read by the recording-medium-type reader is within a predetermined range, and determines as not conformance in other cases.

4. The printing device according to claim 3, further comprising:
a recording-medium-quantity obtainer that obtains a quantity of the recording media which are printable until a temperature of a preset portion of the fixing unit attached in the fixing-unit attachment exceeds a threshold, the recording media being set up on the recording-medium setter; and
a message provider that provides a message according to a determination result by the conformity determiner,
wherein:
the conformity determiner determines whether or not the heating width of the heater in the fixing unit attached in the fixing-unit attachment is wider than the recording width of the recording medium set up on the recording-medium setter; and
the message provider provides information on the quantity of the recording media obtained by the recording-medium-quantity obtainer when the conformity determiner determines as not conformance, and the heating width of the heater in the fixing unit attached in the fixing-unit attachment is determined as being wider than the recording width of the recording medium set up on the recording-medium setter.

5. The printing device according to claim 3, wherein:
the fixing unit comprises a plurality of heaters with different heating widths from one another; and
the conformity determiner selects any one of the plurality of heaters according to the recording width of the recording medium set up on the recording-medium setter.

6. The printing device according to claim 5, wherein one of the plurality of heaters has the heating width conformed to the recording width of the largest recording medium printable by the printing device.

7. The printing device according to claim 1, wherein the recording medium is a cut-out recording medium, or a rolled recording medium longer than the cut-out recording medium.

8. A printing control method comprising:
a recording-medium-type reading step of reading a type of a recording medium;
a fixing-unit attaching step of selectively attaching any one of a plurality of fixing units, the plurality of fixing units being different types from one another; and
a conformity determining step of determining whether or not the type of the fixing unit attached in the fixing-unit attaching step is conformed to the type of the recording medium read in the recording-medium-type reading step.

9. The printing control method according to claim 8, further comprising a message providing step of providing a message according to a determination result of the conformity determining step,
Wherein:
in the message providing step, a message that prompts a replacement of the fixing unit with a type conformed to the type of the recording medium read in the recording-medium-type reading step is provided when a determination is made as not conformance in the conformity determining step.

10. The printing control method according to claim 8, further comprising:
a recording-medium setting step of selectively setting up any one of a plurality of the recording media, the plurality of recording media being different types from one another; and
a fixing-unit-type reading step of reading a type of the fixing unit attached in the fixing-unit attaching step,
wherein:
in the recording-medium-type reading step, a recording width of the recording medium set up in the recording-medium setting step is read;
in the fixing-unit-type reading step, a heating width of the heater in the fixing unit attached in the fixing-unit attaching step is read; and
in the conformity determining step, a determination is made as conformance when a difference between the heating width of the heater in the fixing unit read in the fixing-unit-type reading step and the recording width of the recording medium read in the recording-medium-type reading step is within a predetermined range, and a determination is made as not conformance in other cases.

11. The printing control method according to claim 10, further comprising:
a recording-medium-quantity obtaining step of obtaining a quantity of the recording media which are printable until a temperature of a preset portion of the fixing unit attached in the fixing-unit attaching step exceeds a threshold, the recording media being set up in the recording-medium setting step; and
a message providing step of providing a message according to a determination result of the conformity determining step,
wherein:
in the conformity determining step, a determination is made on whether or not the heating width of the heater in the fixing unit attached in the fixing-unit attaching step is wider than the recording width of the recording medium set up in the recording-medium setting step; and
in the message providing step, information on the quantity of the recording media obtained in the recording-medium-quantity obtaining step is provided
when, in the conformity determining step, a determination is made as not conformance, and the heating width of the heater in the fixing unit attached in the fixing-unit attaching step is determined as being wider than the recording width of the recording medium set up in the recording-medium setting step.

12. The printing control method according to claim 10, wherein:
the fixing unit comprises a plurality of heaters with different heating widths from one another; and
in the conformity determining step, any one of the plurality of heaters is selected according to the recording width of the recording medium set up in the recording-medium setting step.

13. The printing control method according to claim 12, wherein one of the plurality of heaters has the heating width conformed to the recording width of the largest recording medium printable by a printing device.

14. The printing control method according to claim 8, wherein the recording medium is a cut-out recording medium, or a rolled recording medium longer than the cut-out recording medium.

15. A program that causes a computer to execute:
a recording-medium-type reading process of reading a type of a recording medium;
a fixing-unit attaching process of selectively attaching any one of a plurality of fixing units, the plurality of fixing units being different types from one another; and
a conformity determining process of determining whether or not the type of the fixing unit attached in the fixing-unit attaching process is conformed to the type of the recording medium read in the recording-medium-type reading process.

16. The program according to claim 15, further causing the computer to execute a message providing process of providing a message according to a determination result of the conformity determining process,
wherein, in the message providing process, the message that prompts a replacement of the fixing unit with a type conformed to the type of the recording medium read in the recording-medium-type reading process is provided when a determination is made as not conformance in the conformity determining process.

17. The program according to claim 15, further causing the computer to execute:
a recording-medium setting process of selectively setting up any one of a plurality of the recording media, the plurality of recording media being different types from one another; and
a fixing-unit-type reading process of reading a type of the fixing unit attached in the fixing-unit attaching process,
wherein:
in the recording-medium-type reading process, a recording width of the recording medium set up in the recording-medium setting process is read;
in the fixing-unit-type reading process, a heating width of the heater in the fixing unit attached in the fixing-unit attaching process is read; and
in the conformity determining process, a determination is made as conformance when a difference between the heating width of the heater in the fixing unit read in the fixing-unit-type reading process and the recording width of the recording medium read in the recording-medium-type reading process is within a predetermined range, and a determination is made as not conformance in other cases.

18. The program according to claim 17, further causing the computer to execute:
a recording-medium-quantity obtaining process of obtaining a quantity of the recording media which are printable until a temperature of a preset portion of the fixing unit attached in the fixing-unit attaching process exceeds a threshold, the recording media being set up in the recording-medium setting process; and
a message providing process of providing a message according to a determination result of the conformity determining process,
wherein:
in the conformity determining process, a determination is made on whether or not the heating width of the heater in the fixing unit attached in the fixing-unit attaching process is wider than the recording width of the recording medium set up in the recording-medium setting process; and
in the message providing process, information on the quantity of the recording media obtained in the recording-medium-quantity obtaining process is provided when, in the conformity determining process, a determination is made as not conformance, and the heating width of the heater in the fixing unit attached in the fixing-unit attaching process is determined as being wider than the recording width of the recording medium set up in the recording-medium setting process.

19. The program according to claim 17, wherein:
the fixing unit comprises a plurality of heaters with different heating widths from one another;
one of the plurality of heaters has the heating width conformed to the recording width of the largest recording medium printable by a printing device; and
in the conformity determining process, any one of the plurality of heaters is selected according to the recording width of the recording medium set up in the recording-medium setting process.

20. The program according to claim 15, wherein the recording medium is a cut-out recording medium, or a rolled recording medium longer than the cut-out recording medium.
